(19) United States
(12) Patent Application Publication
(10) Pub. No.: US 2011/0297165 A1
(43) Pub. Date: Dec. 8, 2011

(54) MOUTH GUARD

(75) Inventor: Chieh-Min WANG, Cingshuei Township (TW)

(73) Assignee: LIAN CHERNG SPORTS CO., LTD., Cingshuei Township (TW)

(21) Appl. No.: 12/793,378

(22) Filed: Jun. 3, 2010

(51) Int. Cl. A61C 5/14

(52) U.S. Cl. 128/861

(57) ABSTRACT

The mouth guard has an outer cover, an inner cover and a label. The outer cover is U-shaped and pliable and transparent and has a top surface and a mounting groove formed in the top surface. The inner cover is U-shaped and pliable and transparent and has a size smaller than that of the outer cover and mounted in the mounting groove of the outer cover and has a top surface and a teeth groove formed in the top surface of the inner cover. The label is mounted between and covered by the outer cover and the inner cover.

### BACKGROUND OF THE INVENTION

1. Field of the Invention

The present invention relates to a protector, and more particularly to a mouth guard with a label mounted between an outer cover and an inner cover to provide a protecting effect and prevent the label contacting with teeth and mouth.

2. Description of Related Art

A sport player usually wears protections like a knee pad, a shoulder pad, an eye guard etc., to cushion the impact of strenuous exercises like boxing, basketball, football, kickboxing or the like, prevent injury and provide a protecting effect to athletes.

With reference to FIGS. 4 and 5, a convention mouth guard is made of pliable material like rubber or plastic and is mounted on the teeth to cushion the impact. The convention mouth guard is U-shaped and has an outer wall 51, an inner wall 52 and a groove 53. The groove 53 is formed in a top of the mouth guard between the outer wall 51 and the inner wall 52 to contain the teeth. The convention mouth guard further has a mark printed on the outer wall 51, or optionally printed on a label 54 pasted on a front surface or a rear surface of the outer wall 51 to show the maker.

However, because the printed mark on the outer wall 51 contacts with the teeth and mouth so may wear off easily and not be easy to read. Furthermore, before wearing the mouth guard, the mouth guard needs a heating process to be softened for easy wearing. During the heating process, the printed mark or the label 54 probably discolored or discharging poisons and hurts the user's health.

To overcome the shortcomings, the present invention tends to provide a mouth guard to mitigate or obviate the aforementioned problems.

### SUMMARY OF THE INVENTION

The main objective of the present invention is to provide a mouth guard with a label mounted between an outer cover and an inner cover to provide a protecting effect and prevent the label contact with teeth and mouth.

The mouth guard has an outer cover, an inner cover and a label. The outer cover is U-shaped and pliable and transparent and has a top surface and a mounting groove formed in the top surface. The inner cover is U-shaped and pliable and transparent and has a size smaller than that of the outer cover and mounted in the mounting groove of the outer cover and has a top surface and a teeth groove formed in the top surface of the inner cover. The label is mounted between and covered by the outer cover and the inner cover.

Other objects, advantages and novel features of the invention will become more apparent from the following detailed description when taken in junction with the accompanying drawings.

### BRIEF DESCRIPTION OF THE DRAWINGS

FIG. 1 is a perspective view of a mouth guard in accordance with the present invention;

FIG. 2 is an exploded perspective of the mouth guard in FIG. 1;

FIG. 3 is an enlarged cross sectional side view of the mouth guard in FIG. 1;

FIG. 4 is a perspective view of a convention mouth guard with a printed mark; and

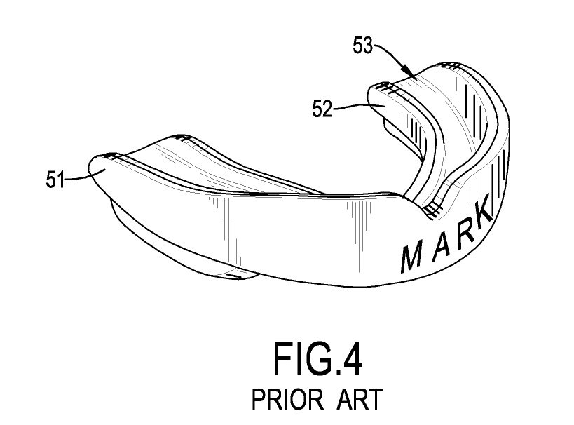

FIG. 5 is an exploded perspective of another convention mouth guard with a pasted label.

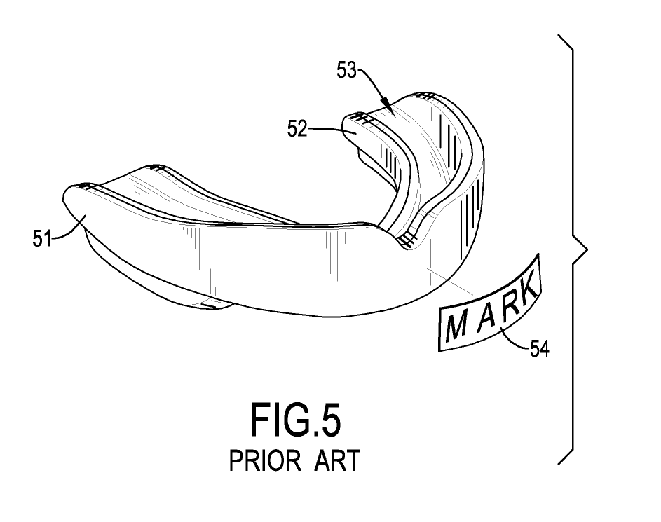

### DETAILED DESCRIPTION OF PREFERRED EMBODIMENT

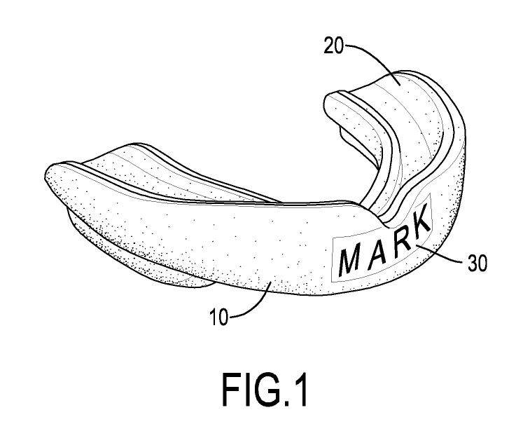

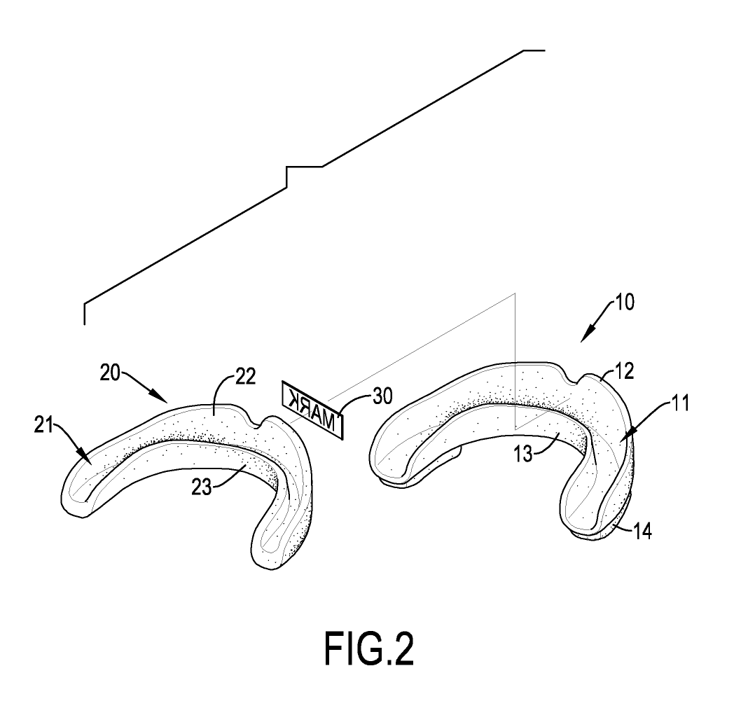

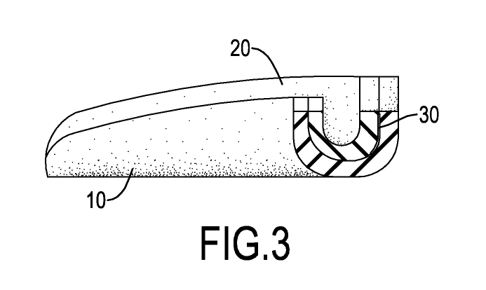

With reference to FIGS. 1 to 3, a mouth guard in accordance with the present invention is U-shaped and has an outer cover 10, an inner cover 20 and a label 30.

The outer cover 10 is U-shaped and made of a pliable and transparent material like rubber and plastic and has a top surface, a bottom surface, a mounting groove 11, an outer wall 12, an inner wall 13 and a cushion 14. The mounting groove 11 is U-shaped and formed in the top surface of the outer cover 10. The outer wall 12 and the inner wall 13 are respectively U-shaped and defined in two sides of the outer cover 10, and the outer wall 12 has a length longer than that of the inner wall 13. The cushion 14 is formed on and protrudes from the bottom surface on two ends of the outer cover 10.

The inner cover 20 is U-shaped and made of a pliable and transparent material like rubber and plastic and has a size smaller than that of the outer cover 10 and mounted in the mounting groove 11 of the outer cover 10. The inner cover 20 has a top surface, a teeth groove 21, an outer board 22 and an inner board 23. The teeth groove 21 is formed in the top surface of the inner cover 20. The outer board 22 and the inner board 23 are respectively U-shaped and defined in two sides of the teeth groove 21, and the outer board 22 has a length longer than that of the inner board 23. The outer board 22 of the inner cover 20 abuts with the outer wall 12 of the outer cover 10. The inner board 23 of the inner cover 20 abuts with the outer wall 13 of the outer cover 10.

The label 30 is printed with a brand mark, a designed pattern, a notice or a name of a maker, and mounted between and covered by the outer wall 12 of the outer cover 10 and the outer board 22 of the inner cover 20.

Because the label 30 is mounted between the outer cover 10 and the inner cover 20 to make the user felt comfortable. The printed colors and chemical composition of the label 30 is covered by the outer wall 12 and the outer board 22 completely and not contacted with the teeth and the mouth to improve safety of use. Furthermore, the outer cover 10 is made of the transparent material and the label 30 may be shown easily and clearly.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A mouth guard comprising:
an outer cover being U-shaped, pliable and transparent and having
a top surface; and
a mounting groove being U-shaped and formed in the top surface of the outer cover;
an inner cover being U-shaped, pliable and transparent, having a size smaller than that of the outer cover, mounted in the mounting groove of the outer cover and comprising
a top surface; and
a teeth groove formed in the top surface of the inner cover; and
a label mounted between and covered by the outer cover and the inner cover.

2. The mouth guard as claimed in claim 1, wherein the outer cover has an outer wall and an inner wall being U-shaped, and the outer wall has a length longer than that of the inner wall;
the inner cover has an outer board and an inner board being U-shaped, the outer board has a length longer than that of the inner board, the outer board abuts with the outer wall, and the inner board abuts with the inner wall; and
the label is mounted between the outer wall of the outer cover and the outer board of the inner cover.

3. The mouth guard as claimed in claim 2, wherein the outer cover further has a bottom surface, two ends and a cushion formed on and protruding from the bottom surface on two ends of the outer cover.
